(19) United States
(12) Patent Application Publication
(10) Pub. No.: US 2007/0271331 A1
(43) Pub. Date: Nov. 22, 2007

(54) System of archiving and repurposing a complex group conversation referencing networked media

(76) Inventor: Steve Muth, Cutchogue, NY (US)

Correspondence Address: DERGOSITS & NOAH LLP, FOUR EMBARCADERO CENTER, SUITE 1450, SAN FRANCISCO, CA, 94111, US

(21) Appl. No.: 11/804,062

(22) Filed: May 17, 2007

Related U.S. Application Data
(60) Provisional application No. 60/801,150, filed on May 17, 2006.

(51) Int. Cl. G06F 15/16

(52) U.S. Cl. 709/203

(57) ABSTRACT

System and method for creating a database of user media and associated user comments wherein the user's comments are collected, collated, stored, and made available to users through a Commenting Theater that allows for the simultaneous representation of and access to the entirety of an archived complex group conversation without reliance upon text. The present invention provides a method for creating electronic collections of media with associated user comments contained and collated into a single entity “VoiceThread Media Player” that has an integral capacity to host a complex electronic conversation and allows content owners to manage a group conversation wherein all of the comments and referenced media remain separate and repurposable data entities and yet both the media content and the resulting conversation are presented in a unified, coherent and casually accessible manner.

### CROSS REFERENCE TO RELATED APPLICATIONS

The present invention claims priority to U.S. patent application for SYSTEM OF ARCHIVING AND REPURPOSING A COMPLEX GROUP CONVERSATION REFERENCING NETWORKED MEDIA, Application No. 60/801,150 filed May 17, 2006.

### BACKGROUND

Today there exists a tremendous desire for sharing media, and to converse our thoughts and comments about it, and yet there is currently no single tool available in which allows an end user to simultaneously consume media and participate in complex group conversations concerning it, and there currently exists no single tool for a content creator to not only publish their media, but to include a forum for discussion within the media product's publishing vehicle. Prior art separates media vehicles from conversations about it, media is consumed in a ‘player’ and then conversations referencing the media take place in a separate contextual environment, i.e. usually a text forum controlled by the website-displaying the media.

The currently described system can casually capture and repurpose complex group conversations referencing shared media; particularly when the conversation takes place across a network and over a variable time period. While there have been developed many forms of networked conversation such as, online forums, e-mail list-servers, web logs, and even the ranking of shared media, they all represent truncated and singular aspects of normal conversations, and none are capable of offering at-a-glance casual access to an entire conversation.

With reference to FIG. 1, we see a commonly used graphical representation of a short conversation involving 10 people with a total of 15 comments. The method employed in FIG. 1 is graphically incapable of displaying the complexity of a true live conversation because the comments must be organized according to one meta data category above all others. In this case the comments are organized by chronology. It is also possible to organize the comments based upon any other meta-data type, i.e. time of comment, subject of comment, author of comment etc., resulting in the commonly used forms found in the prior art. Inevitably there are significant difficulties textually representing complex conversations.

The text based reduction of a conversation as shown in FIG. 1, is a profoundly inefficient method of providing access to a conversation's total complexity in part because it requires choosing only one organizing principle. While even a small child shows the capacity to categorize objects and statements using multiple criteria simultaneously, textual records of conversations cannot render such complexity in an easily usable manner. What is needed is an improved method for displaying electronic messaging between a group of people through a computer network.

### SUMMARY OF THE INVENTION

The present invention provides a system for capturing and converting an asynchronous group conversation about shared media into an apparently synchronous one, using a unique database structure and a novel graphical code called a Commenting Theater. The inventive system significantly enhances accessibility and usability of the asynchronous group conversation.

A VoiceThread Media Player is a collection of media, and references to media, structured to receive comments by invitation of its creator(s). In an embodiment, the invitations are transmitted to a plurality of invitees through network interfaces such as a personal computers and or portable devices etc. In response to the invitations, the invitees prepare and submit their individual comments. The invitee comments are collected by a server computer and assigned metadata as they are collected. As the comments are collected and reviewed, the desired media content is chosen and sequenced is an order specified by a user and placed into the VoiceThread Media Player. The unique Metadata created by interaction with the system is used to reformulate all comments into an easily accessible and navigable format.

The system presented here addresses the shortcomings of all prior tools for the collecting, collating, storing, and repurposing of a plurality of user's comments referencing shared media and made in a network setting, and over time. While there are many potential uses, one instructive example of it's utility is to capture and archive the type of conversation that takes place at a family, social group, business, or academic gathering where media is displayed while members make and share comments. Such conversations have always had great utility and have been enjoyed by people in a broad swath of society but they required a physical presence at a particular time, and archiving, repurposing, and accessing such conversations would normally require the deployment and use of expensive and complex recording equipment.

In one embodiment of the invention, media, or references to media are uploaded to a server and then collated into a VoiceThread Media Player collection by a user. The collection is given a name and assigned a unique identifying code. The metadata includes but is not limited to: name of VoiceThread Media Player, name of creator, date of creation, size, user assigned data tags and description, licensing agreement, copyright information, and available metadata of enclosed media. All of this metadata is stored in the VoiceThread Media Player data file. Upon completion of this process, an uncommented VoiceThread Media Player is created that is ready to be distributed for commentary to invited participants. A further aspect of the preferred embodiment provides a means of displaying without the requirement of text various information including but not limited to: the number of members who have commented on a particular subject media, the number of comments that they have made, the order of their comments, popularity of their comments as well as additional metadata categories.

The subject media is presented in a framed or frameless media space and is surrounded by a channel reserved for avatar thumbnail images the represent the number of users involved in the conversation. As users make their comments, their avatars become visible and functions to represent them in the particular conversation. The avatar may not accompanied by any text in its default view. All additional metadata associated with the avatar is made accessible either through a graphical code, or through a graphical “drawer” mechanism where text information is hidden by default.

A further aspect of the invention provides viewers of the VoiceThread Media Player with access to any part of an extended complex conversation by allowing the click selection of any commenter present regardless of their chronological placement in the conversation.

A further aspect of the invention provides viewers of the VoiceThread Media Player access to any part of a complex conversation by allowing the click selection of any particular comment represented in a graphical Comment Navigation Bar.

This invention's use of a graphical code to represent all parts of an entire complex conversation simultaneously offers users casual access to the conversation in numerous ways: replaying it in chronological order, replaying only comments that have not yet been heard, replaying a single comment, replaying only comments by a single user. Again, without the reliance upon text, the viewer is instantly informed of the number of, location of, and provided access to any particular comment in a complex conversation.

A further aspect of the invention provides for the collection of user comments through a system that automatically adds meta-data to the comment file such as commenter's name and unique identification number, date and time, associated media, and associated VoiceThread Media Player. By collecting and including the above metadata with each comment, a powerful database is created without any additional effort by the user. The comments within the database can now be repurposed so that those made by a particular user, or those made in a particular time period, or those made about particular media, or comments defined by any of the metadata attributes, can be instantaneously repurposed to suit the needs of the user.

A further aspect of the invention is the ability of a single group conversation concerning a single media entity to occur in an infinite number of locations simultaneously. Currently, conversational forums concerning media are not integral to any player of media, but rather to the webpage or website that is displaying the media. So while a piece of media may be displayed in a plurality of locations, the corresponding conversations about this media will be balkanized, occurring only in the contextual space that hosts the media. For example, the same movie clip may be viewed on many different websites but any group conversation about the movie clip is limited to the visitors of each individual website, resulting in a thousand separate conversations. The present invention's integral forum allows for a conversation to be broadly accessible, thereby increasing user participation.

### BRIEF DESCRIPTION OF THE DRAWINGS

Embodiments of the inventive apparatus will be described in more detail with reference to the accompanying drawings in which:

FIG. 1 is a diagram displaying standard graphical reformation of a group conversation to a list format that represents the most common prior art;

FIG. 2 is a diagram of the Commenting Theater in a single room format;

FIG. 3 is a diagram of the Commenting Theater with a two-room format;

FIG. 4 is a diagram of the Comment Navigation Bar;

FIG. 5 is a diagram of a dispersed forum network;

FIG. 6 is a flow chart of the editorial functions of the Two Room format;

FIG. 7 is a diagram of the data structure of a VoiceThread Media Player;

FIG. 8 is a diagram of the data structure of the user data file; and

FIG. 9 is an example of a Commenting Theater.

### DETAILED DESCRIPTION

In a preferred embodiment of this invention, the system is used as a method for displaying media with an integral ability to accept and display user commentary about the media. The media can be a photo, a video segment, an audio recording or any other type of media that participants can comment upon. When a participant comments on the media, an avatar representing the participant is automatically generate within an avatar channel space reserved for the conversation participants.

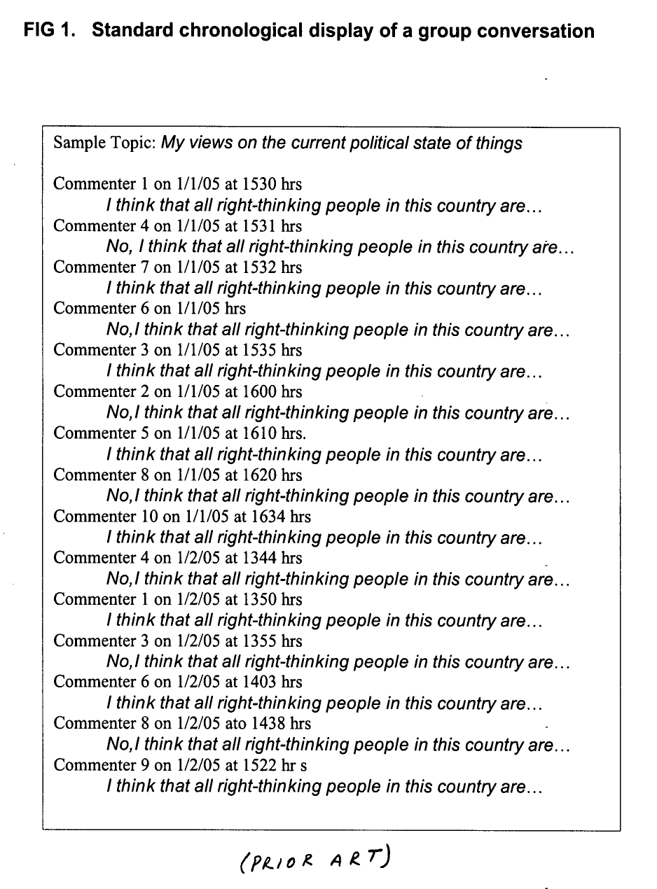

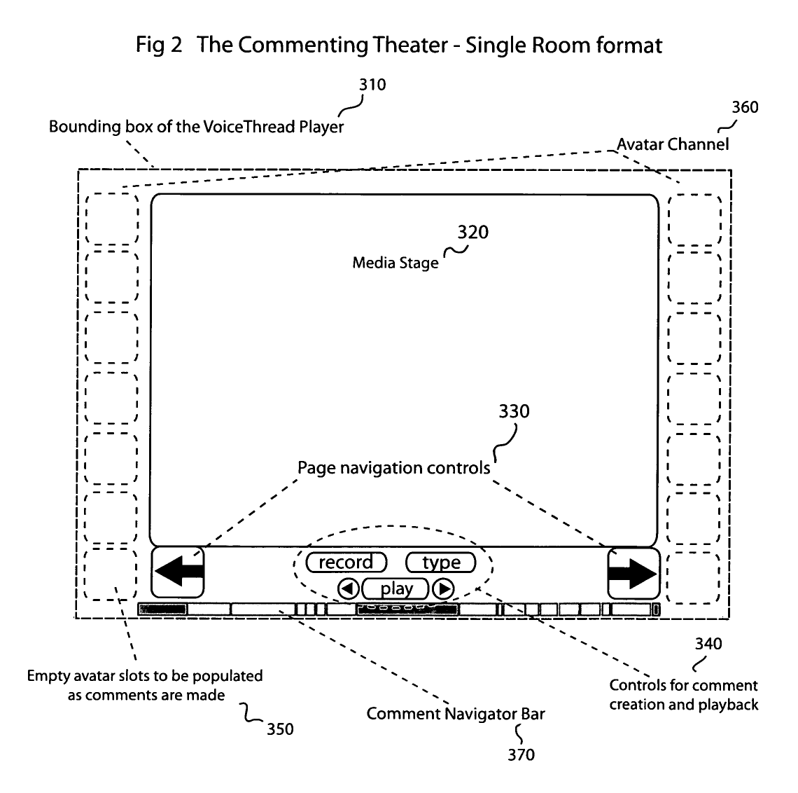

Rather than the lines of text representing the communications depicted in FIG. 1., in an embodiment, the inventive system uses a device called a Commenting Theater. One possible configuration of the Commenting Theater is a VoiceThread Player 310 shown in FIG. 2. In this embodiment, the subject media is centrally positioned on a media stage 320 and is surrounded by an avatar channel having multiple avatars 360 that functions as a metaphor of the physical space that encompasses an actual live conversation. Invited users may participate in the conversation by commenting using the commenting controls 340. Successful use of the commenting controls 340 causes an avatar thumbnail image of the participant to appear and represent their comment. This avatar channel 360 will automatically populate with the avatars of participants as they enter the conversation. The display of the avatars mimics the physical arrival of a new participant in the location of a live oral conversation. All avatars within the Commenting Theater of the VoiceThread Player 310 are displayed by default with no textual information. The graphical design and symbology may represent the meta-data of, but is not limited to, presence, popularity, chronological order, number of comments, relative length of comments, etc.

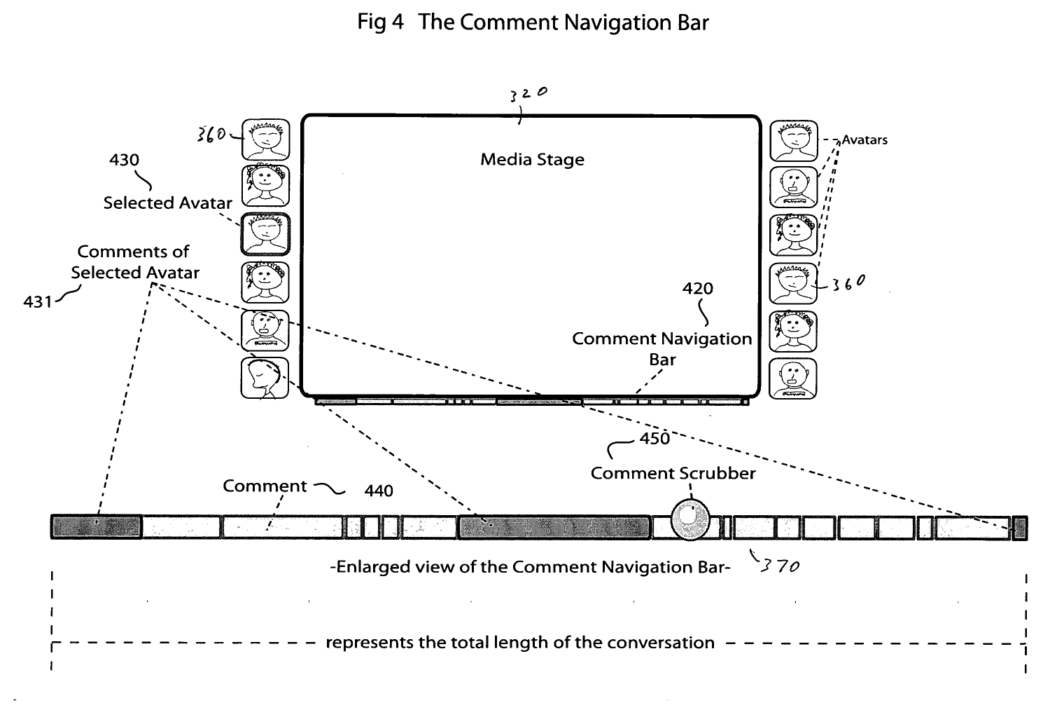

A preferred embodiment utilizes a Comment Navigation Bar 370. A more detailed illustration of an embodiment of the Comment Navigation Bar 440, media stage 320 and avatars 360 as displayed is illustrated in FIG. 4a. FIG. 4b is an enlarged view of the Comment Navigation Bar 370 that displays and provides access to any point within a complex conversation. The length of the Comment Navigation Bar 370 represents the total length of the conversation and each segment represents a different comment. The comments are sequentially arranged from left to right, with the first comment on the left side of the Comment Navigation Bar 370 and the last comment is on the right side. The graphical length of each of the comment segments represents the duration of each comment.

In an embodiment, a participant's first comment can be played simply by clicking on their avatar in the avatar channel. The comments made by the participant are graphically displayed as highlighted segments 431 of the Comment Navigation Bar 370. The Comment Navigation Bar also illustrates the number of comments that were made in response to a comment by the selected participant in a conversation, their lengths relative to each other, how many comments has a particular participant made, and when the comments were made within the chronological timeline of the conversation. In FIG. 4, the selected avatar 430 is the third avatar down on the left side. This avatar selection can be done by positioning a cursor over the avatar and clicking a select button. In response to the avatar selection, the Comment Navigation Bar highlights a number of comment segments 431 that were made by the selected avatar. As discussed, the sequence of comments is from left to right. Subsequent to the selected avatar's first comment, there are six comments and subsequent to the selected avatar's second comment there are nine comments having a variety of durations.

Importantly, the Comment Navigation Bar 370 can also allow include a Comment Scrubber 450 that is used to quickly access any point in a complex conversation. The Comment Scrubber 450 may be click-dragged to any location within the entire conversation to provide near-instant access to any commentary. When the Comment Scrubber 450 is released, the system plays the selected conversation segment and subsequent segments of the Comment Navigation Bar 370. The selected avatar 430 that is making the comment may be highlighted as the Comment Scrubber 450 travels over and presents each comment segment.

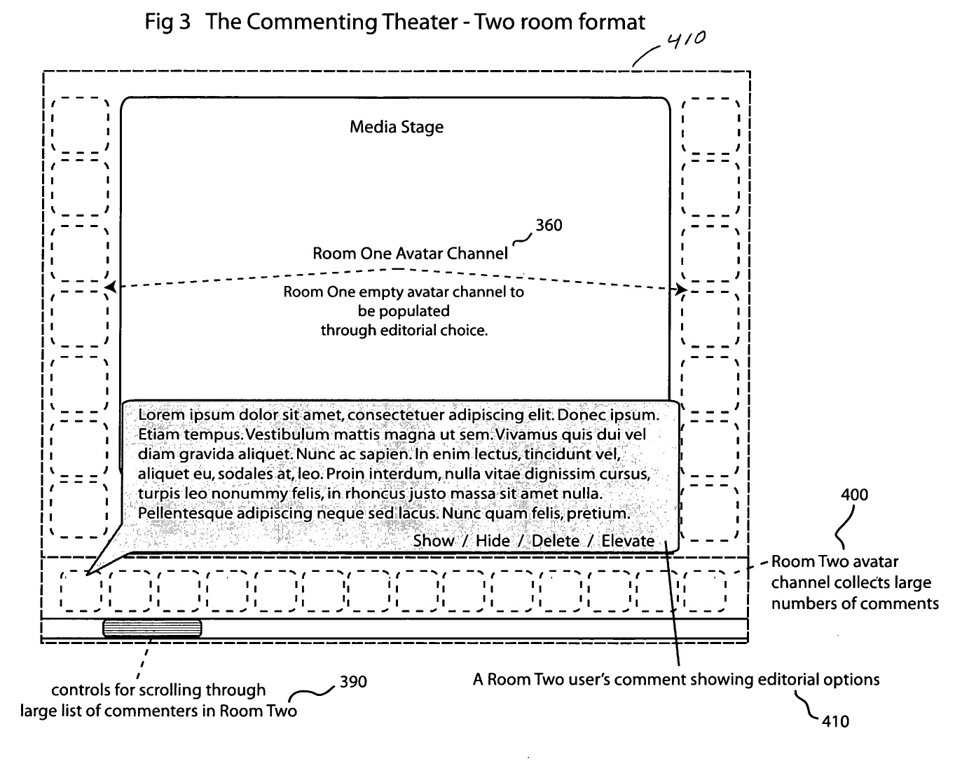

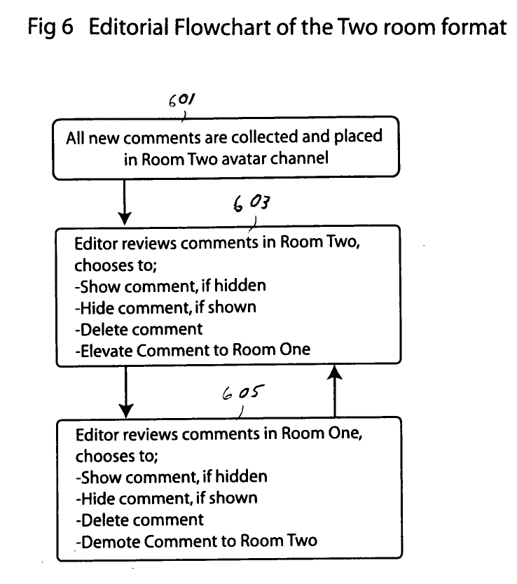

In an embodiment, the VoiceThread Media Player 410 has a Two Room format that is illustrated in FIGS. 3 and 6. The Two Room format adds an additional avatar channel 400 positioned on the bottom of the screen that acts a ‘waiting room’ for avatars. This additional avatar channel 400 may be able to scroll which would potentially provide a limitless avatar capacity. Like the previous examples, the upper left and right side portions of the VoiceThread Media Player 410 that represent the first room avatar channel 360. With reference to FIG. 6, the editor may use the following procedures to process the room two comments. All new participant's comments are added to the Room Two avatar channel 400, which employs a scrolling mechanism 390 to facilitate a potentially limitless number of commenters who may participate 601. A viewer can clicking on or place a cursor over the desired participant's avatar in the Room Two channel 400 to access the room two participant's comments.

In an embodiment, the room two participant's comments are moderated by an editor or editors so that the way that room two participant's comments are displayed on the VoiceThread Media Player can be controlled. The editor moderates the conversation by choosing from various editorial options such as: show, hide delete and elevate when reviewing any of the individual comments 603. If the editor selects the show option, the room two participant's comments are publicly visible to all invited users. Alternatively, if the editor chooses the ‘Hide’ option, the participants comments are made invisible to all but the editor(s) and the commenter. Using the delete option, the comments may be deleted altogether.

If the ‘Elevate’ option is selected, the comment by the Room Two participant is moved up into the Room One avatar channel. If a Room Two comment is elevated, the avatar associated with the person making the comment may also be moved or copied to the Room One avatar channel 360. There are various other possible editor control options. The described Two Room format thereby allows the creator(s) of the VoiceThread Media Player 410 to manage and curate an extremely large discussion forum where all of the commentary is easily accessible and yet the most useful and compelling commentary is presented and grouped together in the Room One avatar channel 360.

In an embodiment, these same editorial controls can be applied to the comments in Room One. The editor of Room One may reviewing any or all of the individual comments. In the same manner described above, the editorial options can include: show, hide and delete 603. The editor can decided to demoted a comment made by a Room One participant so that it is only published in Room Two. The associated avatar may also be moved or copied from the Room One avatar channel 360 to the Room Two avatar channel 400.

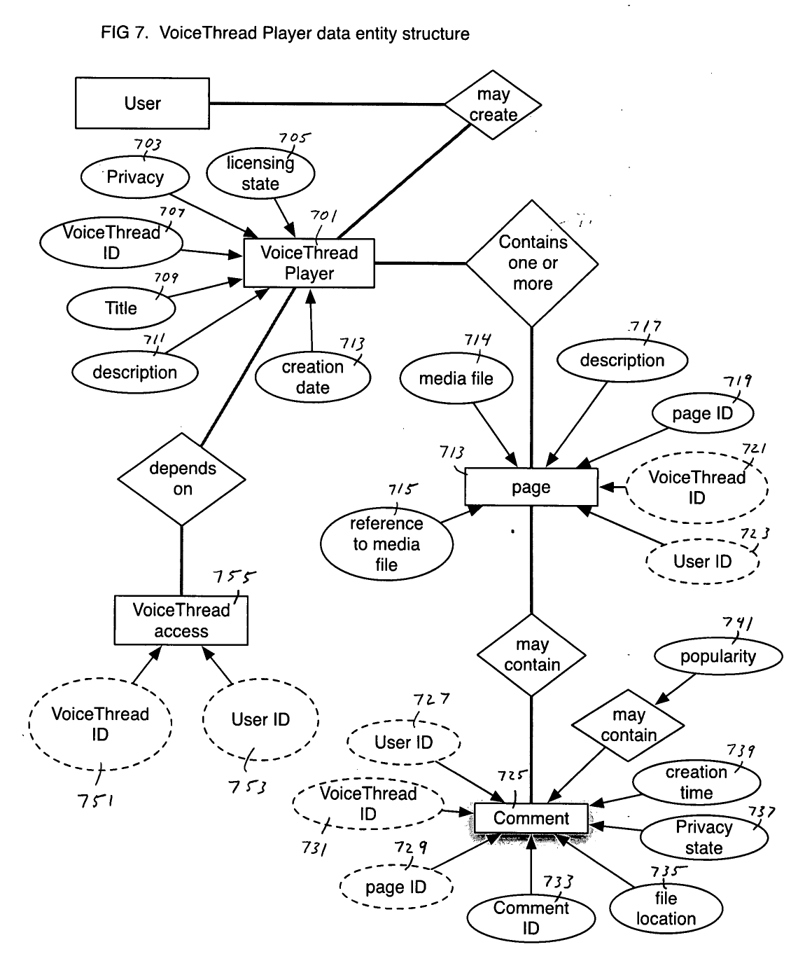

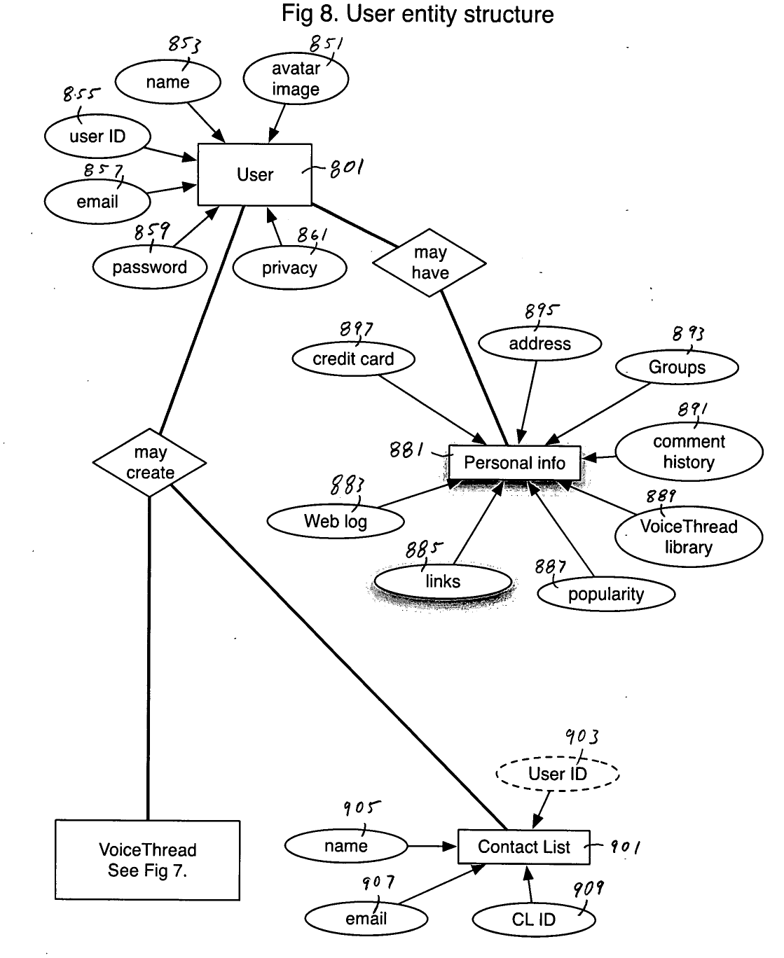

The editor's ability to curate the commentary enables a compact and succinct summary of the most compelling commentary to be easily browsed and consumed by a casual visitor to the VoiceThread Media Player 410. A preferred embodiment utilizes a database structure and data entities within the database that allow for the collection, organization, storage, and repurposing of archived group conversations. These data entities and relationships are shown as charts in FIGS. 7 and 8.

The chart shown in FIG. 7 is a possible configuration of metadata associated with the VoiceThread Player 701 and the pages 731 displayed on the VoiceThread Player 701. FIG. 7 specifies that the VoiceThread Media Player data structure that may contain, but is not limited to, the following types of meta data:
1. Privacy state 703, a “public” VoiceThread Media Player may be published on a list of publicly viewable VoiceThread Media Players, a private VoiceThread Media Player is not publicly listed and requires an invitation from the creator to view
2. Licensing state 705, must have a defined licensing status indicating the creator's preferred method of publication
3. VoiceThread Media Player ID 707, a unique identifier of every VoiceThread Media Player
4. Title 709
5. Description 711, a text description of the contents of the VoiceThread Media Player which contains searchable text
6. Creation date 713
7. VoiceThread Media Player Page(s) 713 data entity

The VoiceThread Player 701 contains one or more 715 VoiceThread Pages. The VoiceThread Pages data entity may contain, but is not limited to, the following types of meta data.
1. A media file and associated meta data 714
2. A referenced to media file 715 and associated meta data
3. Text description 717, a text description of the contents of the media file that contains searchable text
4. VoicePage page ID 719, a unique identifier of every VoicePage
5. The VoiceThread Media Player ID 721 of the hosting VoiceThread Media Player
6. The user ID 723 of the creator of the VoiceThread Media Player
7. Comment data entity(s) 725

The VoiceThread Pages 713 may also contain comments 725. The comment data entity may contain, but is not limited to, the following types of metadata:
1. a user ID 727 of the comment's author
2. the VoicePage ID 729 of the hosting VoicePage
3. the VoiceThread Media Player ID 731 of the hosting VoiceThrea Media Player
4. a comment ID 733
5. file location 735 of the audio or text comment
6. privacy state 737 of the comment
7. a creation time 739 of the comment
8. a popularity rating 741

The user's access to the VoiceThread Player 701 depends upon the VoiceThread ID 751 and the User ID 753. If this information is submitted and authorized, the user can access 755 the stored pages 713 and view the pages through the VoiceThread Player 701.

In an embodiment, the User ID 753 is obtained by setting up a user file. FIG. 8 is a chart showing the information within a User file. A user file may contain, but is not limited to the following types of meta data:
1. a user name 853
2. a unique user identifier 855
3. an e-mail address of the user 857
4. a password 859
5. a privacy preference 861
6. an avatar thumbnail image of the user 851

The user file may also contain personal information 881 which may include but is not limited to the following meta data types:
1. location of web log 883
2. user specified shared links 885
3. a popularity rating 887
4. a VoiceThread Media Player library 889 which may include a listing of the VoiceThread Media Players created by the user, as well as those bookmarked by user
5. a comment history 891 catalog of users comments
6. names of groups 893 that a user has chosen to affiliate with
7. user mailing address 895
8. user credit card information 897

The user file may also contain an associated contact list created by the user. The contact list 901 is a data entity containing the basic user account information of registered users selected by the user. Each entry in the contacts list 901 may include but is not limited to: user ID 903, contact name 905, contact e-mail 907 and contact list ID 909. Once the user file is created and the VoiceThread Player access is granted, the user can create pages for the VoiceThread Player as illustrated in FIG. 7.

In contrast to existing text based message displays, in a live person-to-person conversation, comments are made casually, usually while looking at the persons and or subject. Once a comment has been made, we then look to our fellow conversant for a response. While ad-hoc metadata is of course present in all live conversations, i.e. the persons involved have names and the comments are made at a particular time in a particular place, this data, while usually known, remains invisible, and for good reason. The display of unnecessary textual metadata is distracting and requires the unnecessary notation of, and cerebral processing of data that is likely immaterial to the user. The display of, and the processing and evaluation of this immaterial metadata in a text form inhibits the ability for an archived complex conversation to seem casual, thereby inhibiting accessibility and usability.

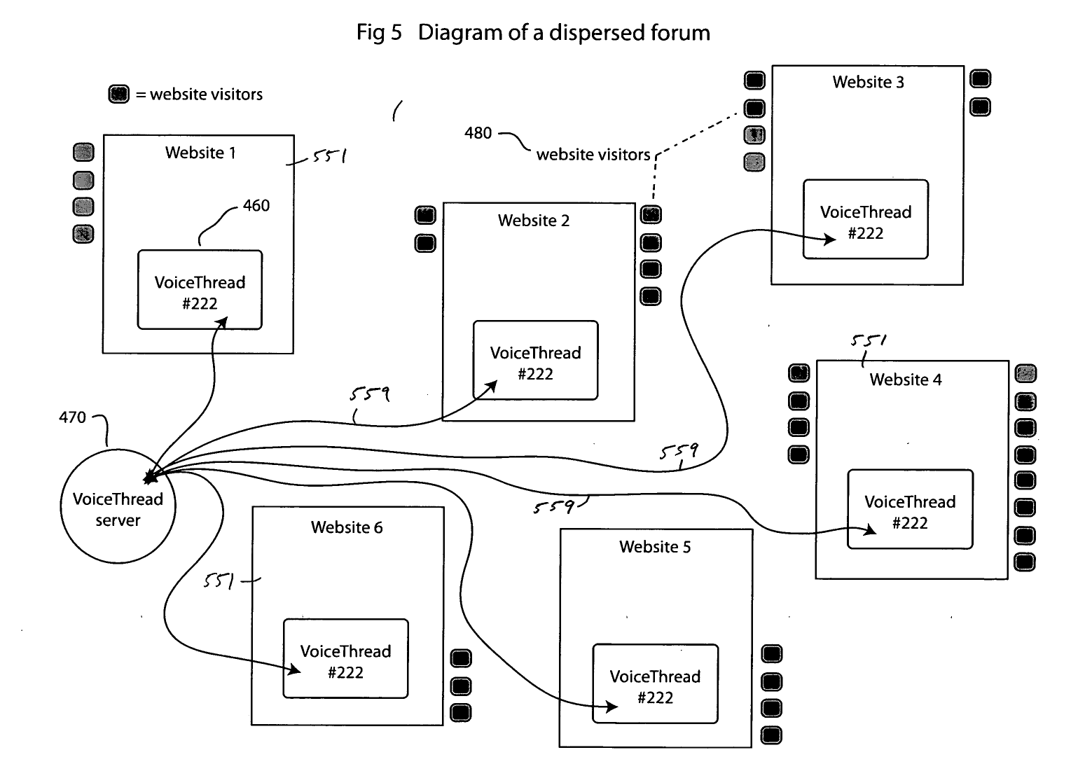

A preferred embodiment of the invention uses the network structure shown in FIG. 5. whereby a conversational forum is made integral to media presented within the VoiceThread Media Player, unlike prior art wherein conversational forums are integral to a single website presenting the media. FIG. 5. Shows the VoiceThread Server 470 creating and distributing a single VoiceThread Media Player to six different websites 551 through a network 559 such as the internet, allowing the content of the VoiceThread Media Player #222 460 to simultaneously harvest the attention of the sum of all of the website visitors 480 of all of the websites wherein it resides. Each of these websites may be similar in appearance to the VoiceThread Media Players shown in FIGS. 2, 3, 4 and 6. The small squares on each VoiceThread Media Player represent the individual visitors 480 to each of these web sites 551.

This structure fundamentally shifts ownership of a conversational forum from the website owner to the media content owner and allows these content owners to directly harvest the rewards of creating compelling content, rewards including, but not limited to, the display of a single source of copyrighted material and advertising. In an embodiment, an advertising message may occupy a portion of the display. When a user clicks on the advertising portion of the display the system can respond in a number of ways. In a first embodiment, an advertising browser window can be opened on top of the VoiceThread Media Player window. The new advertising browser window may include access to the advertiser's web site or provide a smaller advertising display that includes links to the advertiser's web site. Rather than having individuals download copyrighted material and reposting the copyrighted material on individual websites, the inventive system allows the owner of the copyrighted material to transmit the material to many different websites. The operator may collect revenues based upon the clicks on the advertisements shown on the VoiceThread Media Player.

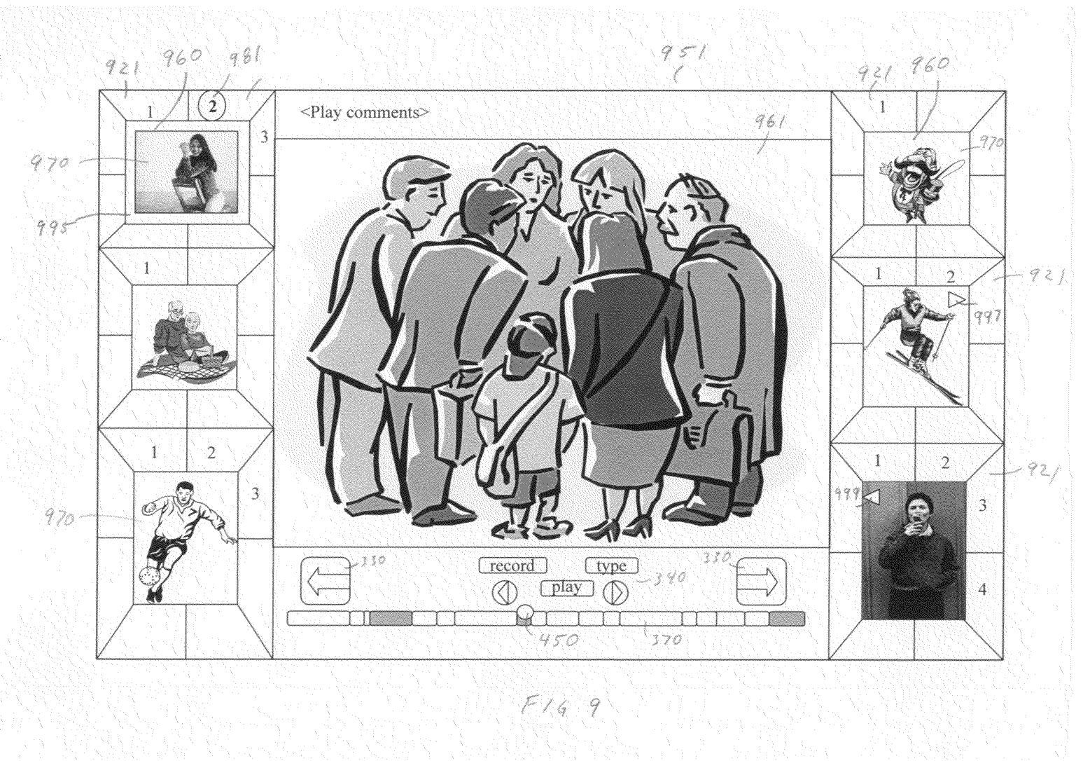

With reference to FIG. 9, an example of an embodiment of the VoiceThread Media Player 951 is illustrated. In this example, the media stage 961 is occupied by a family photo and the avatars 970 surrounding the center photo in the Room One avatar channel 960 are avatars of the invitees who might be family members and friends. The avatars 970 have been assigned or created by the users and may include photos, illustrations, caricatures, etc. There are three avatars 970 on the left side of the media stage 961 and three avatars 970 on the right side. In this embodiment, there are comment indicators 921 that are numbered in polygons around each of the avatars 970 that indicate the comments associated with each avatar 970. In an embodiment, the comment indicators 921 can be used with or without the navigation controls. The viewer can hear each comment by placing a cursor over the comment indicators or by dragging the comment scrubber 450 over the desired segment of the navigation bar 370. In this illustration, comment scrubber 450 has moved to the second comment by the avatar 970 in the upper right. To indicate that the avatar 970 is being played, a “halo” 995 has been placed around the avatar 970. There may also be an indicator 981 that specifies which comment is from the avatar 970 is being played. In other embodiments any other method for indicating which avatar's comment is being played may be applied. Also as discussed above, all other comments by this avatar 970 have been indicated in the comment navigation bar 370. There is also a right facing triangle 997 in the middle right avatar indicating that this is the next avatar 970 to comment and a left facing triangle 999 in the lower right avatar indicating that the previous comment was from this avatar 970. In other embodiments there are other methods for indicating which avatar's comment was previously played and which avatar's comment is next to be played.

As discussed, the VoiceThread Media Player can be used to play back archived media and comments. Once all of the avatars have been created and all of the comments have been recorded, an editor can edit the comments and organize them in any order. Frequently this will be chronological but the comments can also be automatically organized based upon the message metadata or manually organized as desired by the editor. The organized information can then be saved by the editor and stored on a server so that they can be accessed and viewed by any authorized viewer computer that has access to the server.

In an embodiment, the authorized viewer can review an archived piece of media and associated comments by logging onto a website provided by the server computer and after confirming authorization, the server will allow the viewer access to listings of media. The listings may include a thumbnail of the media, a text description of the media or other indications of the media. The viewer may have access to all public media and some private media depending upon the viewer's authorization. For example, the viewer may have access to media assembled by friends and family and other public media, but may not have access to private media prepared by unknown participants. In some embodiments, a single electronic document includes the media, avatars and comments information. In other embodiments, an electronic folder is associated with the media and the folder contains different documents for the media, avatars and comments.

As discussed, the inventive system is displays a media which can be any type of presentable information, including but not limited to: artistic images, digital photographs, text, video clips, audio tracks, etc. The media can be in any appropriate format including: jpeg, pdf, mp3, mp4, etc. In an embodiment, the common format of the media is converted by the inventive system to a proprietary format that can be presented by the Media Player but cannot be easily duplicated electronically. This proprietary format conversion feature is applied to the media submitted by the user before distribution to the commenting theater and allows the owners of the copyrighted subject media to control the distribution of the media and prevent unauthorized duplication of the subject media.

The discussion can be a series of audio messages recordings about the media which are played back through the VoiceThread Media Player. This works very well for purely visual media, but can also be applied as a supplement to the audio portion of the media. The relative volumes of the audio portion of the media and the participants' comments can be adjusted so that both can be clearly heard simultaneously. In other embodiments, the Player displays text which represents the participants' comments. Thus, if the media has an audio component, a person can listen to the media's audio component and simultaneously read the comments. The comment text may be displayed sequentially in an order based upon any selected metadata in a space on the Player such as adjacent to or within the media stage.

While the present invention has been described in terms of a preferred embodiment above, those skilled in the art will readily appreciate that numerous modifications, substitutions and additions may be made to the disclosed embodiment without departing from the spirit and scope of the present invention. It is intended that all such modifications, substitutions and additions fall within the scope of the present invention that is best defined by the claims below.

What is claimed is:

1. A method of presenting electronic media comprising:
configuring a commenting theater that includes a subject media;
storing the commenting theater in a memory of a server computer;
transmitting the commenting theater to a plurality of invitee computers through a network;
displaying the commenting theater on the invitee computers;
creating a plurality of avatars that each represent one of the invitees;
recording comments about the subject media from the invitee computers through the commenting theater; and
displaying the avatar that is associated with the comment around at least a portion of the subject media in the commenting theater after the comment has been recorded.

2. The method of presenting electronic media of claim 1 further comprising:
transmitting recorded comments to the server computer; and
storing the recorded comments and the subject media in the memory of the server computer; and
storing a plurality of additional media and associated comments in the memory of the server computer.

3. The method of presenting electronic media of claim 2 further comprising:
providing a plurality of viewer computers.

4. The method of presenting electronic media of claim 3 further comprising:
displaying a listing for the plurality of additional media and the associated comments on the plurality of viewer computers.

5. The method of presenting electronic media of claim 4 further comprising:
selecting one of the additional media and the associated comments with one of the viewer computer; and
displaying the additional media and playing the associated comments on a player software program on the viewer computer.

6. A method of presenting electronic media comprising:
configuring a commenting theater that includes a subject media;
storing the commenting theater in a memory of a server computer;
transmitting the commenting theater to a plurality of invitee computers through a network;
displaying the commenting theater on the invitee computers;
creating a plurality of avatars that each represent one of the invitees;
transmitting comments about the subject media from the invitee computers through the commenting theater to the server computer; and
broadcasting the comments from the invitee computers and displaying the avatar that is associated with the comment around at least a portion of the subject media in the commenting theater as each of the comments is transmitted to the server computer from the invitee computers.

7. The method of presenting electronic media of claim 6 further comprising:
recording the comments from the invitee computers in a memory of the server computer; and
storing the media and the avatars of the invitees in the memory of the server computer.

8. The method of presenting electronic media of claim 7 further comprising:
providing a searchable database containing a plurality of electronic data recordings that each include media data, comment data and avatar data in the memory of the server computer.

9. The method of presenting electronic media of claim 8 further comprising:
providing an authorization system in the server computer that prevents unauthorized access to at least some of the data recordings in the searchable database.

10. The method of presenting electronic media of claim 8 further comprising:
browsing through the database with a viewer computer;
selecting a first recording in the database;
transmitting the first recording to the viewer computer;
displaying the media and playing the associated comments of the recording on the viewer computer.

11. A method of presenting electronic media comprising:
configuring a commenting theater that includes a subject media;
storing the commenting theater template in a memory of a server computer;
transmitting the commenting theater template to server computers which each have an associated web site;
transmitting commenting theaters from the server computers to a plurality of computers through the internet;
displaying the commenting theaters on the computers;
creating a plurality of avatars that each represent a user of the computers;
transmitting comments about the subject media from the invitees through the commenting theater; and
displaying the avatar that is associated with the comment around at least a portion of the subject media in the commenting theater after the comment has been recorded.

12. The method of presenting electronic media of claim 11 further comprising:
recording the comments about the subject media; and
recording metadata for the comments that includes at least one of the following types of information: popularity, chronological order, number of comments and relative length.

13. The method of presenting electronic media of claim 11 further comprising:
displaying a comment navigation bar having a plurality of segments that are arranged sequentially and each represent one of the comments.

14. The method of presenting electronic media of claim 13 further comprising:
displaying a comment scrubber;
positioning the comment scrubber over a segment of the comment navigation bar; and
playing the comments sequentially from the segment of the comment navigation bar that the comment scrubber is position over.

15. The method of presenting electronic media of claim 11 further comprising:
displaying the plurality of avatars in a scrolling loop so that only some of the plurality of avatars are displayed on the commenting theater and all of the avatars are accessible through the commenting theater.

16. The method of presenting electronic media of claim 15 further comprising:
providing commenting theater controls which include a scroll control for scrolling through the plurality of avatars displayed and selection controls for selecting an avatar for playing.

17. The method of presenting electronic media of claim 11 further comprising:
displaying a first group of the plurality of avatars in a first channel area of the commenting theater; and
displaying a second group of the plurality of avatars in a second channel area of the commenting theater.

18. The method of presenting electronic media of claim 16 further comprising:
displaying all of the comments from the first group of the avatars;
screening the comments from the second group of the avatars for content;
deleting the comments from the second group of the avatars that do not provide the required content; and
displaying the comments on the commenting theater from the second group of the avatars that provide the required content.

19. The method of presenting electronic media of claim 11 wherein the commenting theaters of the server computers operate independently and play the same subject media.

20. The method of presenting electronic media of claim 11 further comprising:
converting the media to a proprietary format that is stored in the memory of the server and processed by the commenting theater but prevents the media from being copied.
